(19) United States
(12) Patent Application Publication
(10) Pub. No.: US 2020/0260494 A1
(43) Pub. Date: Aug. 13, 2020

(54) RADIO BASE STATION AND USER DEVICE

(71) Applicant: NTT DOCOMO, INC., Tokyo (JP)

(72) Inventors: Hideaki Takahashi, Tokyo (JP); Tooru Uchino, Tokyo (JP)

(73) Assignee: NTT DOCOMO, INC., Tokyo (JP)

(21) Appl. No.: 16/637,610

(22) PCT Filed: Aug. 7, 2018
(86) PCT No.: PCT/JP2018/029615

§ 371 Date: Feb. 7, 2020

(30) Foreign Application Priority Data
Aug. 10, 2017 (JP) 2017-155955

(51) Int. Cl. H04W 74/08; H04W 36/30

(52) U.S. Cl. CPC H04W 74/0833; H04W 36/305

(57) ABSTRACT

eNB (100A) configures a split bearer that goes from a core network via SCG and from the SCG splits toward the eNB (100A) included in MCG. The eNB (100A) reconfigures, when UE (200) reconnects to the same SCG as that before release of resources, the split bearer that uses retained upper layer resources. The UE (200) executes a random access procedure with gNB (100B) included in the SCG to which the UE (200) is reconnected.

### TECHNICAL FIELD

The present invention relates to a radio base station and a user device that are capable of configuring a split bearer.

### BACKGROUND ART

3rd Generation Partnership Project (3GPP) specifies Long Term Evolution (LTE), and with an aim of further speeding, specifies LTE-Advanced (hereinbelow, the LTE includes the LTE-Advanced). Moreover, in the 3GPP, specifications of a successor system of the LTE called 5G New Radio (NR) and the like are being studied.

Specifically, as a type of a bearer in dual connectivity (DC) using a radio base station of an LTE system and a radio base station of an NR system, a split bearer via a secondary cell group (SCG) (Split bearer via SCG) is stipulated in Non-Patent Document 1.

In the Split bearer via SCG, when a master base station is the radio base station of the LTE system (hereinafter, “LTE MeNB”) and a secondary base station is the radio base station of the NR system (hereinafter, “NR SgNB” or simply “SgNB”), the bearer for a user plane (S1-U) between a core network and the radio base station is configured only between the core network (EPC (Evolved Packet Core)) and the NR SgNB. The bearer splits toward the LTE MeNB at the PDCP layer of the NR SgNB and constitutes a split bearer.

User data (for example, downlink data) is transmitted to a user device (User Equipment, UE) from the LTE MeNB and the NR SgNB via the split bearer. Accordingly, the dual connectivity using the LTE MeNB and the NR SgNB is realized.

### PRIOR ART DOCUMENT

### Non-Patent Document

Non-Patent Document 1: 3GPP TR 38.804 V14.0.0 Section 5.2.1.2 Bearer types for Dual Connectivity between LTE and NR, 3rd Generation Partnership Project; Technical Specification Group Radio Access Network; Study on New Radio Access Technology; Radio Interface Protocol Aspects Release 14), 3GPP, March 2017

### SUMMARY OF THE INVENTION

As explained above, a configuration in which, when a secondary base station is a radio base station of the NR system (NR SgNB), the LTE MeNB forms a macro cell and the NR SgNB forms a small cell is stipulated in Non-Patent Document 1.

In such a configuration, when UE moves, it is assumed that the UE frequently goes out of the coverage area of the small cell. Therefore, if a split bearer via the SCG is configured, it is necessary to release that split bearer and reconfigure a new bearer via only a master cell group (MCG).

Furthermore, it is assumed that when the UE moves into the coverage area of the small cell after the split bearer is released, a new split bearer is configured and the dual connectivity is resumed. In other words, increase in the signaling amount due to such release and configuration of the split bearer becomes a concern.

As a solution to such a problem, one approach is to use a mechanism stipulated in LTE Release-12. Specifically, in the LTE Release-12, it is stipulated that, upon detecting a radio link failure of SCG (S-RLF), a certain radio base station (SeNB) that forms Primary SCell (PSCell) reports to the master base station (MeNB) the RLF, and the MeNB that receives the report performs operation to remove the SCG.

In such a configuration, to suppress the increase in the signaling amount due to the release and configuration of the split bearer explained above, a solution in which the MeNB that has received the report can retain the resources in the SCG without releasing the same can be thought.

However, if the MeNB retains the resources of the SCG, once the SCG recovers from the radio link failure and the UE returns to the SCG (PSCell), the MeNB reconfigures the split bearer (Split bearer via SCG) while using the retained resources. Therefore, a delay associated with the configuration occurs and causes instantaneous interruption in data communication.

The present invention has been made in view of the above circumstances. One object of the present invention is to provide, when a split bearer via a secondary cell group (SCG) is configured, a radio base station and a user device capable of both suppressing the signaling caused due to the repeated release and configuration of the split bearer and reduce the delay associated with the reconfiguration of the split bearer.

A radio base station according to one aspect of the present invention is a radio base station (eNB 100A) in a radio communication system (radio communication system 10) that is capable of configuring a first bearer (split bearer B_{SP}) that goes from a core network via a secondary cell group and from the secondary cell group splits toward the radio base station included in a master cell group, and in which data is transmitted to a user device (UE 200) via the first bearer. The radio base station includes a failure notification receiving unit (failure notification receiving unit 130) that receives from the user device a failure notification that indicates occurrence of a radio link failure (S-RLF) in the secondary cell group; a resource controlling unit (resource controlling unit 140) that, when the failure notification receiving unit receives the failure notification, releases only resources from a layer lower than a predetermined layer (RLC layer) in the secondary cell group of the first bearer and retains resources of a layer (PDCP layer and above) upper than the predetermined layer; and a random access procedure executing unit (random access procedure executing unit 150) that executes random access procedure with the user device. The resource controlling unit reconfigures, when the user device reconnects to the same secondary cell group as that before the release of the resources, the first bearer using the retained upper layer resources. The random access procedure executing unit instructs, when the first bearer is reconfigured, the user device to execute the random access procedure with another radio base station (gNB 100B) that is included in the secondary cell group to which the user device is reconnected.

A user device according to another aspect of the present invention is a user device in a radio communication system that is capable of configuring a first bearer that goes from a core network via a secondary cell group and from the secondary cell group splits toward a radio base station included in a master cell group, and in which data is transmitted to the user device via the first bearer. The user device includes a failure notifying unit (failure notifying unit 230) that transmits to the radio base station a failure notification that indicates occurrence of a radio link failure in the secondary cell group; a random access procedure executing unit that executes a random access procedure; a quality measuring unit (quality measuring unit 250) that measures a reception quality of a cell in the secondary cell group; and a connection controlling unit (connection controlling unit 220) that reconnects the user device to the secondary cell group when the reception quality of the cell measured by the quality measuring unit is equal to or higher than a predetermined threshold value. Only resources from a layer lower than a predetermined layer in the secondary cell group of the first bearer are released and resources of a layer upper than the predetermined layer are retained when the radio link failure occurs. The connection controlling unit reconfigures the first bearer when the user device reconnects to the same secondary cell group as that before the release of the resources. The random access procedure executing unit executes the random access procedure with another radio base station that is included in the secondary cell group to which the user device is reconnected, when the first bearer is reconfigured.

### BRIEF DESCRIPTION OF DRAWINGS

FIG. 1 is an overall structural diagram of a radio communication system 10.

FIG. 2 is a diagram showing a protocol stack of eNB 100A (LTE MeNB) and gNB 100B (NR SgNB).

FIG. 3 is a functional block diagram of the eNB 100A and the gNB 100B.

FIG. 4 is a functional block diagram of UE 200.

FIG. 5 is a diagram showing a control sequence of a split bearer that includes a scenario in which a radio link failure (S-RLF) in a secondary cell group has occurred (operation example 1).

FIG. 6 is a diagram showing another control sequence of a split bearer that includes a scenario in which a radio link failure (S-RLF) in a secondary cell group has occurred (operation example 2).

FIG. 7 is a diagram showing a configuration example of a split bearer B_{SP} (Split bearer via SCG).

FIG. 8 is a diagram showing a configuration example of a split bearer B_{SP} (Split bearer via SCG) (after a part of resources is released).

FIG. 9 is a diagram showing an example of a hardware configuration of the eNB 100A, 100B and the UE 200.

### MODES FOR CARRYING OUT THE INVENTION

Exemplary embodiments of the present invention are explained below with reference to the accompanying drawings. Furthermore, in the drawings, structural elements having the same function or configuration are indicated by the same or similar reference numerals and the explanation thereof is appropriately omitted.

### (1) Overall Structural Configuration of Radio Communication System

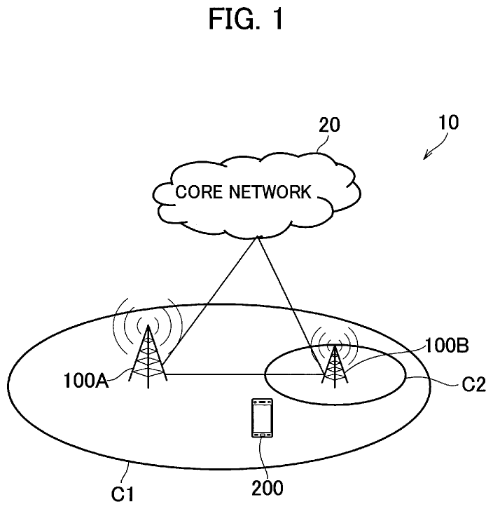

FIG. 1 is an overall structural diagram of a radio communication system 10 according to the present embodiment. The radio communication system 10 is a radio communication system that uses the Long Term Evolution (LTE) and the 5G New Radio (NR), and includes a core network 20 and a user device 200 (hereinafter, “UE 200”). A radio base station 100A (hereinafter, “eNB 100A”) and a radio base station 100B (hereinafter, “gNB 100B”) are connected to the core network 20.

The core network 20 can be a core network of the LTE system (EPC (Evolved Packet Core)) or a core network of the NR system (NextGen Core, 5GC).

In the present embodiment, the eNB 100A is a radio base station (eNB) of the LTE system, and can constitute a master base station. Hereinafter, the eNB 100A will be appropriately represented as LTE MeNB (or simply MeNB). The gNB 100B is a radio base station (gNB) of the NR system, and can constitute a secondary base station. Hereinafter, the gNB 100B will be appropriately called as NR SgNB (or simply SgNB).

The eNB 100A forms a cell C1. The gNB 100B forms a cell C2. In the present embodiment, the cell C1 is a macro cell and the cell C2 is a small cell. There can be a plurality of the cell C1 and the cell C2.

A master cell group (MCG) is constituted by the cell C1 formed by the eNB 100A. A secondary cell group (SCG) is constituted by the cell C2 formed by the gNB 100B.

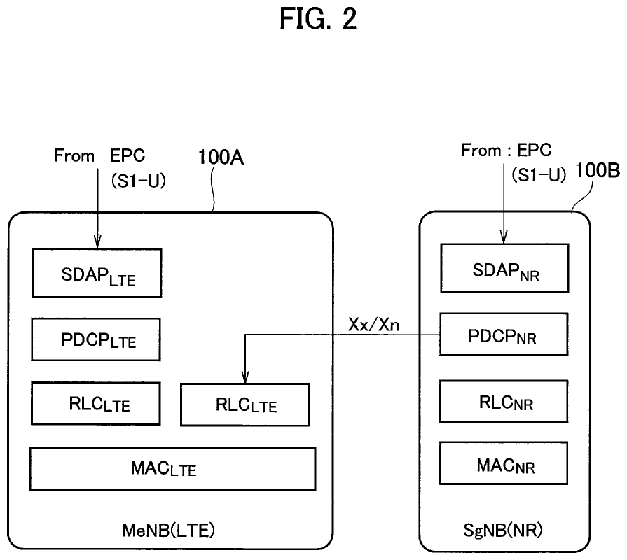

FIG. 2 shows a protocol stack of the eNB 100A (LTE MeNB) and the gNB 100B (NR SgNB). As shown in FIG. 2, the eNB 100A includes MAC (Medium Access Control) layer (MAC_{LTE}), RLC (Radio Link Control) layer (RLC_{LTE}), PDCP (Packet Data Convergence Protocol) layer (PDCP_{LTE}), and AS (Access Stratum) sublayer, specifically, Service Data Application Protocol layer (SDAP_{LTE}).

Similarly, the gNB 100B includes MAC (Medium Access Control) layer (MAC_{NR}), RLC (Radio Link Control) layer (RLC_{NR}), PDCP (Packet Data Convergence Protocol) layer (PDC_{PNR}), and AS (Access Stratum) sublayer, specifically, Service Data Application Protocol layer (SDAP_{NR}). The SDAP_{NR} is necessary when connecting to the NextGen Core. When connecting to the EPC, layers stipulated as per the conventional QoS mechanism are necessary.

A control plane (C plane) and a user plane (U plane) are configured between the core network 20 (EPC) and the eNB 100A, but only the U plane is configured between the core network 20 (EPC) and the gNB 100B.

Each of the eNB 100A and the gNB 100B includes, a not shown physical layer below the MAC layer. Moreover, the AS sublayer (the SDAP_{LTE} and the SDAP_{NR}) includes RRC (Radio Resource Control) such as RRC Connection Reconfiguration and the like explained later.

The eNB 100A and the gNB 100B are connected to the core network 20 (EPC) via S1-U interface. Moreover, the eNB 100A and the gNB 100B are connected to each other via X interface (Xx/Xn). As shown in FIG. 2, the eNB 100A includes the RLC layer (RLC_{LTE}) for the X interface, and connects to the PDCP layer (PDCP_{NR}) of the gNB 100B via the X interface.

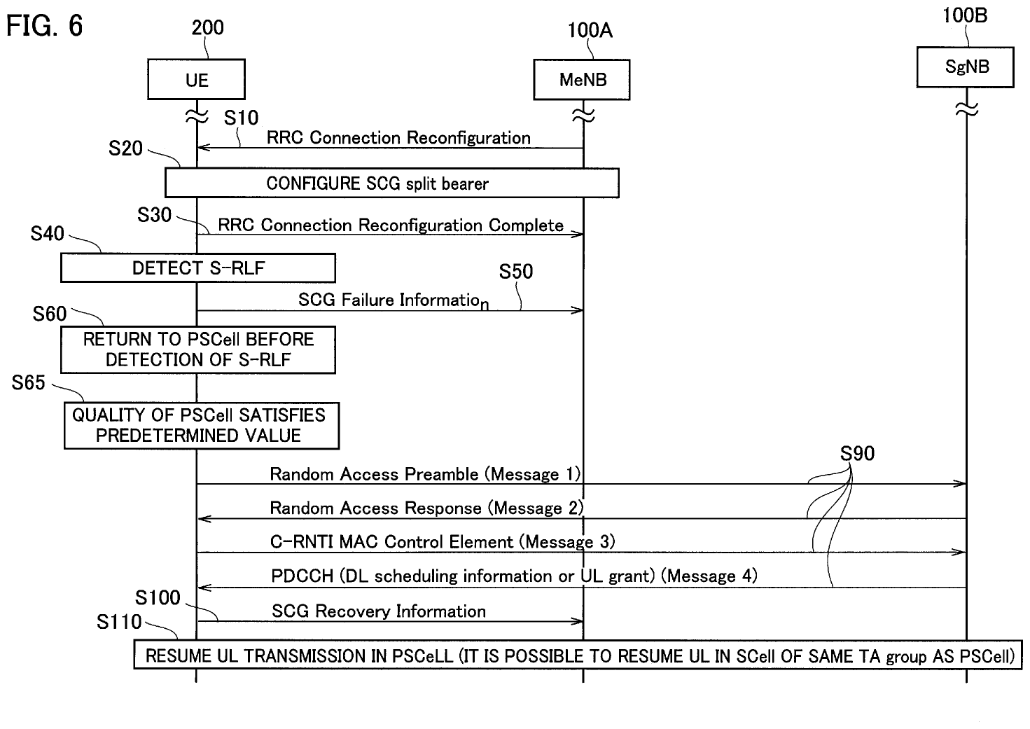

Moreover, in the present embodiment, a split bearer B_{SP} (not shown in FIG. 2, see FIG. 6 and the like) that goes from the core network 20 via the secondary cell group (SCG) and from the secondary cell group splits toward the radio base station (eNB 100A) included in the master cell group (MCG), specifically, Split bearer via SCG is configured. In the present embodiment, the split bearer B_{SP} constitutes a first bearer.

Data transmitted from the core network 20 to the UE 200, specifically, downlink user data is transmitted to the UE 200 via the split bearer B_{SP}.

### (2) Functional Block Configuration of Radio Communication System

A functional block configuration of the radio communication system 10 is explained below.

Specifically, functional block configurations of the eNB 100A and the UE 200 are explained below.

(2.1) eNB 100A and gNB 100B

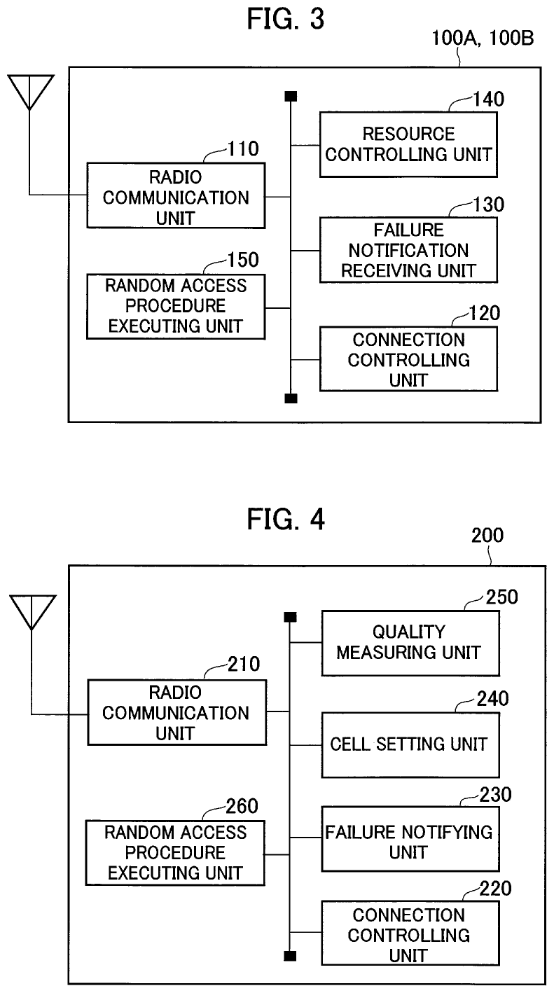

FIG. 3 is a functional block diagram of the eNB 100A and the gNB 100B. Hereinafter, unless particularly stated, the eNB 100A is cited as an example. As explained above, in the present embodiment, the gNB 100B is different from the eNB 100A in that the gNB 100B is the radio base station of the NR system and constitutes the secondary base station.

As shown in FIG. 3, the eNB 100A includes a radio communication unit 110, a connection controlling unit 120, a failure notification receiving unit 130, a resource controlling unit 140, and a random access procedure executing unit 150.

The eNB 100A provides functions of each layer in the protocol stack shown in FIG. 2 via the functional blocks shown in FIG. 3. Furthermore, in FIG. 3, only the functional blocks related to the present invention are shown.

The radio communication unit 110 performs radio communication using the LTE system. Specifically, the radio communication unit 110 transmits to/receives from the UE 200 a radio signal using the LTE system. The user data or control data is multiplexed in the radio signal.

The connection controlling unit 120 controls the connection between the eNB 100A and the UE 200, and the connection between the eNB 100A and the gNB 100B. Specifically, the connection controlling unit 120 controls the connections with the UE 200 in the RRC layer. Moreover, the connection controlling unit 120 controls the connections with the gNB 100B via the X interface (Xx/Xn).

In particular, in the present embodiment, the connection controlling unit 120 transmits to the UE 200 a connection message (RRC message) to configure the split bearer B_{SP} (see FIG. 6 and the like). Specifically, the connection controlling unit 120 is capable of transmitting to the UE 200 the RRC Connection Reconfiguration that includes an information element that allows the UE 200 to deactivate the secondary cell group (SCG) under a predetermined condition.

In the present embodiment, “to deactivate” means setting to a state in which the resources used for configuring the split bearer B_{SP} are retained without releasing, but, as an operation of the UE 200, it indicates that any uplink signal of the cell is not transmitted and a Physical downlink control channel (PDCCH), too, is not monitored. The UE 200 performs a downlink quality measurement by using downlink synchronization/reference signals and the like, but the measurement period is longer than that in the RRC Connected state.

Moreover, the connection controlling unit 120 can transmit to the UE 200 the RRC Connection Reconfiguration that includes an information element that allows the UE 200 to remove an identifier of the cell quality measurement in the SCG. Specifically, the RRC Connection Reconfiguration can include an information element that allows the UE 200 to remove MeasId that is used for identifying the quality measurement performed by the UE 200 of Primary SCell (PSCell) and Secondary Cell (SCell) included in the SCG.

Specifically, the MeasId is stipulated in Chapter 6.3.5 and the like of 3GPP TS36.331, and is used for identifying the configuration of the quality measurement of the cell (for example, the relationship between a measurement object (measObject) and a report configuration (reportConfig)). When the UE 200 removes the MeasId in the SCG, the quality measurement in the SCG is stopped. In other words, when the UE 200 removes the MeasId, the quality measurement in the SCG is not performed.

Moreover, the connection controlling unit 120 can transmit to the gNB 100B (another radio base station) a resource modification request (Secondary Node Modification Request) that instructs to release only the resources from a layer below the predetermined layer in the SCG of the split bearer B_{SP}.

Specifically, when the failure notification receiving unit 130 receives a failure notification (S-RLF), the connection controlling unit 120 can transmit to the gNB 100B the Secondary Node Modification Request that instructs the gNB 100B to release the resources from a layer below the RLC layer, in other words, the resources of the RLC_{NR} and the MAC_{NR} (including the physical layer) of the gNB 100B.

When a part of the resources that constitute the split bearer B_{SP} is released in such a manner, when reconnecting the UE 200 to the same SCG (that is, the gNB 100B) as that before the release of the resources, the connection controlling unit 120 (corresponds to the gNB 100B in the present embodiment) can configure the split bearer B_{SP} in which the released resources are reused.

On the other hand, when a part of the resources that constitute the split bearer B_{SP} is released in the manner explained above, when connecting the UE 200 to a different SCG than that before the release of the resources, the connection controlling unit 120 (corresponds to the gNB 100B in the present embodiment) can configure a new split bearer B_{SP}.

The failure notification receiving unit 130 receives from the UE 200 a notification of the radio link failure (RLF) in the master cell group (MCG) and the secondary cell group (SCG). In particular, in the present embodiment, the failure notification receiving unit 130 receives from the UE 200 a failure notification (SCG Failure Information) that indicates that the RLF in the SCG (referred to as S-RLF) has occurred.

The resource controlling unit 140 controls the resources in each layer of the protocol stack shown in FIG. 2. Specifically, the resource controlling unit 140 controls the resources required in each layer according to the set state of the master cell group (MCG) and the secondary cell group (SCG).

In particular, in the present embodiment, the resource controlling unit 140 (corresponds to the gNB 100B in the present embodiment) releases, based on the resource modification request (Secondary Node Modification Request) received from the eNB 100A, the resources from the predetermined layer and below (specifically, from the RLC layer and below) in the SCG of the split bearer B_{SP}.

In other words, the resource controlling unit 140 releases only the MAC_{NR} and the RLC_{NR}, among the MAC_{NR}, the RLC_{NR}, the PDC_{PNR}, and the SDAP_{NR} (see FIG. 2) that constitute the split bearer B_{SP}.

Moreover, when the failure notification receiving unit receives the failure notification, the resource controlling unit 140 can release only the resources from a layer below the predetermined layer in the SCG of the split bearer B_{SP}, while retaining the resources of the layers above the predetermined layer (PDCP layer and above).

The resource controlling unit 140 can reconfigure, when the UE 200 reconnects itself to the same SCG (that is, the gNB 100B) as that before the release of the resources, the split bearer B_{SP} by using the retained upper layer resources.

The random access procedure executing unit 150 executes a random access procedure with the UE 200. Specifically, the random access procedure executing unit 150 executes random access procedure that includes reception of Random Access Preamble (Message 1) from the UE 200 and transmission of Random Access Response (Message 2) to the UE 200 and the like.

Moreover, when the split bearer B_{SP} is reconfigured after the occurrence of S-RLF, the random access procedure executing unit 150 instructs the UE 200 to execute the random access procedure with the gNB 100B (another radio base station) included in the SCG to which the UE 200 is reconnected.

Specifically, the random access procedure executing unit 150 can instruct the UE 200 to execute random access procedure with the PSCell included in the SCG, via the physical downlink control channel (PDCCH).

The random access procedure executing unit 150 instructs the UE 200 to execute the Contention based Random Access procedure in the PSCell, by using the predetermined bits of the PDCCH. Moreover, the random access procedure executing unit 150 can specify an RA preamble and instruct the UE 200 to execute a Contention free Random Access procedure.

Alternatively, the random access procedure executing unit 150 can instruct the UE 200 to execute a random access procedure with the PSCell via the control element (CE) of the MAC layer (Medium Access Control layer). The random access procedure executing unit 150 can instruct the UE 200 to execute, similar to the case of PDCCH, the Contention based Random Access procedure or the Contention free Random Access procedure.

Moreover, the random access procedure executing unit 150 can prioritize, when a plurality of timing advance groups (TAGs) exists in the SCG, the execution of the random access procedure with the cells belonging to the timing advance group (pTAG) that includes the PSCell.

Specifically, when there is plurality of TAGs in the SCG, the random access procedure executing unit 150 can instruct the UE 200 to execute the random access procedure with the sTAG after the completion of the random access procedure with the pTAG (the TAG including the PSCell).

The TAG is a group based on transmission timings of uplink (UL) transmissions from a plurality of UEs, specifically, a group of component carriers (CC) that have substantially the same propagation delay among the CCs set in the UE.

(2.2) UE 200

FIG. 4 is a functional block diagram of the UE 200. As shown in FIG. 4, the UE 200 includes a radio communication unit 210, a connection controlling unit 220, a failure notifying unit 230, a cell setting unit 240, a quality measuring unit 250, and a random access procedure executing unit 260. The UE 200 provides functions of each layer in the protocol stack shown in FIG. 2 via the functional blocks shown in FIG. 4. Furthermore, in FIG. 4, only the functional blocks related to the present invention are shown.

The radio communication unit 210 performs radio communication using the LTE system and the NR system. Specifically, the radio communication unit 210 transmits to/receives from the eNB 100A a radio signal using the LTE system. Moreover, the radio communication unit 210 transmits to/receives from the gNB 100B a radio signal using the NR system. The user data or control data is multiplexed in the radio signal.

The connection controlling unit 220 controls the connection between the UE 200 and the eNB 100A, and the connection between the UE 200 and the gNB 100B. Specifically, the connection controlling unit 220 controls the connections in the RRC layer, based on the connection message (RRC message) transmitted from the eNB 100A or the gNB 100B.

More specifically, the connection controlling unit 220 performs, based on the RRC Connection Reconfiguration received from the eNB 100A (or the gNB 100B), a connection reconfiguration process in the RRC layer. The connection controlling unit 220 transmits to the eNB 100A (or the gNB 100B) RRC Connection Reconfiguration Complete that indicates that the connection reconfiguration process is completed.

Moreover, when the cell reception quality measured by the quality measuring unit 250 is equal to or higher than the predetermined threshold value, the connection controlling unit 220 reconnects the UE 200 to the SCG. As explained above, only the resources from the layer below the predetermined layer (RLC layer) in the SCG of the split bearer B_{SP} can be released and the resources of the layers above the predetermined layer (PDCP layer and above) can be retained because of the occurrence of the radio link failure (S-RLF).

In such a case, the connection controlling unit 220 can reconfigure, when reconnecting the UE 200 to the same SCG as that before the release of the resources, the split bearer B_{SP}.

The failure notifying unit 230 detects the radio link failure (RLF) in the master cell group (MCG) and the secondary cell group (SCG). In particular, in the present embodiment, based on the detection condition of the RLF stipulated in the 3GPP Technical Standard (TS) (for example, Chapter 10.1.6 of T536.300), the failure notifying unit 230 detects the RLF in the SCG.

Moreover, the failure notifying unit 230 transmits to the eNB 100A, a failure notification that indicates that the radio link failure (S-RLF) has occurred in the SCG.

Furthermore, the failure notifying unit 230 can reconfigure the split bearer B_{SP}, and can transmit to the eNB 100A a return notification that indicates that the UE 200 has returned to the SCG. Specifically, the failure notifying unit 230 transmits to the eNB 100A, an SCG recovery Information that indicates that the UE 200 has returned to the SCG.

The cell setting unit 240 performs settings related to the cells of the master cell group (MCG) or the secondary cell group (SCG) to which the UE 200 is connectable. Specifically, the cell setting unit 240 deactivates the SCG in a predetermined case.

More specifically, when the RRC message (RRC Connection Reconfiguration) received by the connection controlling unit 220 includes the information element that allows deactivation, and when the radio link failure (RLF) in the SCG is detected, the cell setting unit 240 deactivates the setting of the cell (the cell C2 in the present embodiment) included in the SCG.

In particular, in the present embodiment, even when the UE 200 is not allowed to autonomously deactivate the setting of the cell included in the SCG, if such an information element is included in the received RRC Connection Reconfiguration and the RLF in the SCG is detected, the cell setting unit 240 deactivates the setting of the cell included in the SCG.

Moreover, when the RRC message (RRC Connection Reconfiguration) received by the connection controlling unit 220 includes an information element that allows removal of the identifier of the cell quality measurement in the SCG, and when the radio link failure (RLF) in the SCG is detected, the cell setting unit 240 stops the quality measurement of the cell (the cell C2 in the present embodiment) included in the SCG.

The quality measuring unit 250 measures a reception quality of the cells included in the master cell group (MCG) and the secondary cell group (SCG). Specifically, the quality measuring unit 250 measures a reception quality of the cells (cell reception quality) included in the MCG the SCG.

The quality measuring unit 250 measures Reference Signal Received Power (RSRP), Reference Signal Received Quality (RSRQ), and the like of each cell, and transmits a report of measurement (Measurement Report) if a predetermined condition (entering condition) is fulfilled.

In particular, in the present embodiment, after a part of the resources (from the RLC layer and below) of the split bearer B_{SP} in the gNB 100B (NR SgNB) is released, the quality measuring unit 250 can measure the reception quality in the SCG for a longer period than that before the release of the resources.

The random access procedure executing unit 260 executes a random access procedure with the eNB 100A or the gNB 100B. In particular, in the present embodiment, when the split bearer B_{SP} is reconfigured, the random access procedure executing unit 260 executes the random access procedure with the gNB 100B (another radio base station) included in the SCG to which the UE 200 is reconnected.

Moreover, when a plurality of timing advance groups (TAGs) exists in the SCG, the random access procedure executing unit 260 can execute, similar to the random access procedure executing unit 150 (see FIG. 3), the random access procedure with the cells belonging to the timing advance group (pTAG) that includes the PSCell.

### (3) Operation of Radio Communication System

Operation of the radio communication system 10 is explained below. Specifically, operations related to the configuration and the release of the split bearer (Split bearer via SCG) performed by the eNB 100A (LTE MeNB), the gNB 100B (NR SgNB), and the UE 200 will be explained.

### (3.1) Operation Example 1

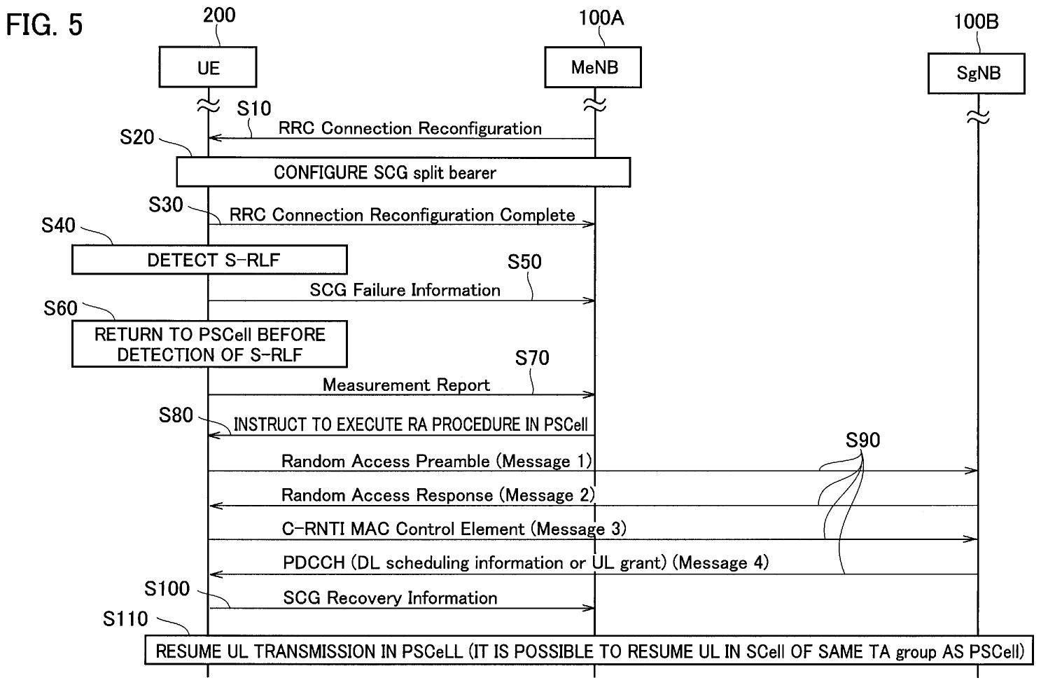

FIG. 5 shows a control sequence of a split bearer that includes a scenario in which a radio link failure (S-RLF) in a secondary cell group has occurred (operation example 1).

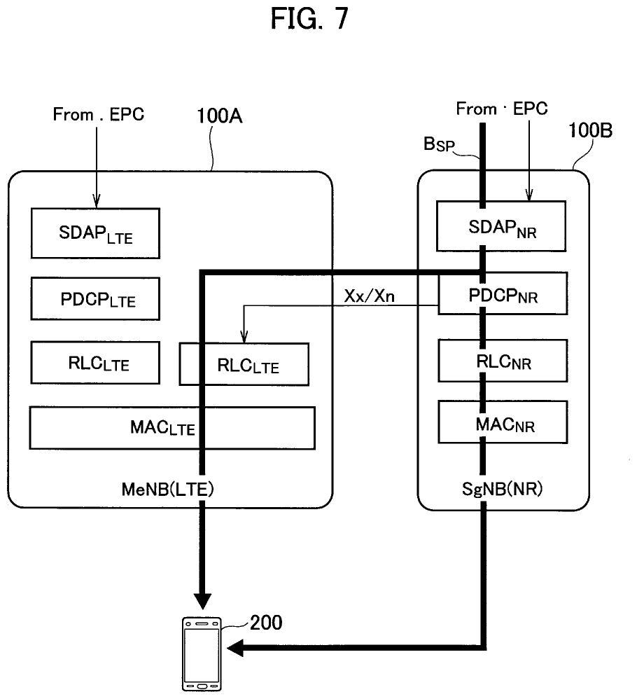

FIG. 7 shows a configuration example of a split bearer B_{SP} (Split bearer via SCG). As shown in FIG. 7, the split bearer B_{SP} (shown with a thick line), which is the Split bearer via SCG, splits at the PDC_{PNR} of the gNB 100B toward the eNB 100A. Furthermore, a path of the configurable bearers (not limited to the split bearers) (see 3GPP TR38.804) is indicated by a thin line.

The split bearer B_{SP} that is split toward the eNB 100A provides a logical communication path to the UE 200 via the RLC_{LTE} and the MAC_{LTE} of the eNB 100A. Moreover, the split bearer B_{SP} provides a logical communication path to the UE 200 via the RLC_{NR} and MAC_{NR} of the gNB 100B. In the present operation example, the SCG split bearer as shown in FIG. 7 is configured.

As shown in FIG. 5, the eNB 100A transmits to the UE 200 the RRC Connection Reconfiguration that requests the configuration of the split bearer B_{SP} (SCG split bearer) (Step S10). As explained above, the split bearer B_{SP} is referred to as the Split bearer via SCG, but in the figure the split bearer B_{SP} is appropriately called as “SCG split bearer” for convenience.

Based on the received RRC Connection Reconfiguration, the UE 200 configures the split bearer B_{SP} and transmits to the eNB 100A the RRC Connection Reconfiguration Complete (Steps S20 and S30).

Next, upon detecting the RLF in the SCG (S-RLF), the UE 200 transmits to the eNB 100A the failure notification (SCG Failure Information) that indicates that the S-RLF has occurred (Steps S40 and S50).

As a result, in the gNB 100B, the resources from the layer below the RLC_{NR} layer of the split bearer B_{SP} are released.

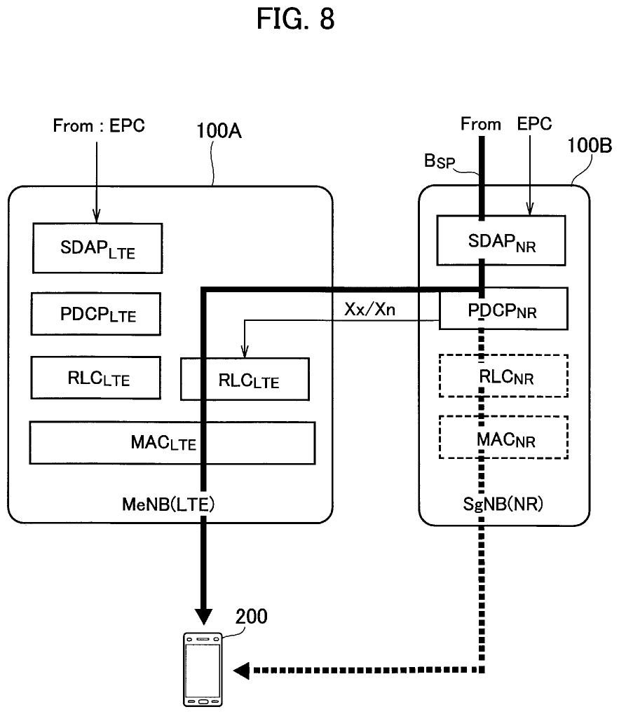

FIG. 8 shows a configuration example of a split bearer B_{SP} (Split bearer via SCG) (after apart of the resources is released). As shown in FIG. 8, because the resources from the layer below the RLC_{NR} layer of the gNB 100B are released, the split bearer B_{SP} (the resources that constitute the split bearer B_{SP}) within a section that directly moves toward the UE 200 from the gNB 100B (shown with a dotted line in the figure) is released.

In this manner, when the S-RLF is detected, a part of the split bearer B_{SP} is released. Therefore, the UE 200 can perform the measurement reporting (transmitting Measurement Report) for a longer period than that when the SCG is in the active state. Accordingly, the power consumption of the UE 200 is reduced. Moreover, because the split bearer B_{SP} at the MCG side itself retains the configuration, the signaling caused due to the repeated release and configuration of the split bearer can be suppressed.

Subsequently, the UE 200 returns (Step S60) to the PSCell of the SCG to which it was connected before the detection of S-RLF (Step S40). As reasons for the UE 200 returning to the PSCell before the S-RLF detection, improvement in the cell reception quality of the PSCell, failure recovery of the PSCell (gNB 100B), and the like can be cited.

The UE 200 transmits to the eNB 100A a Measurement Report about cells, specifically, the PSCell and the SCell, included in the SCG (Step S70).

Based on the received Measurement Report (Reference Signal Received Power (RSRP), Reference Signal Received Quality (RSRQ), Signal-to-Interference plus Noise power Ratio (SINR), and the like), the eNB 100A instructs the UE 200 to execute the random access procedure in the PSCell when it is judged that the UE 200 can be reconnected to the PSCell (Step S80).

The UE 200 executes, based on an instruction to execute the random access procedure, a random access procedure with the gNB 100B that forms the PSCell (Step S90). Specifically, the UE 200 transmits a Random Access Preamble (Message 1) to the gNB 100B. The gNB 100B returns a Random Access Response (Message 2).

Subsequently, the messages (C-RNTI MAC Control Element (Message 3) and PDCCH (DL scheduling information or UL grant) (Message 4)) stipulated in the random access procedure are transmitted/received. At this step, the random access procedure is completed.

The UE 200 transmits to the eNB 100A, the SCG recovery Information upon the completion of the random access procedure (Step S100). The SCG recovery Information, as explained above, indicates that the UE 200 has returned to the SCG and UL transmission has been resumed. The SCG recovery Information, for example, can be stipulated as RRC layer message.

When the random access procedure is completed, the transmission (UL transmission) using uplink (UL) in the PSCell is resumed (Step S110). Moreover, the SCell included in timing advance group (TAG) same as that of the PSCell can also resume the UL transmission in a similar manner.

### (3.2) Operation Example 2

FIG. 6 shows a control sequence of a split bearer that includes a scenario in which a radio link failure (S-RLF) in a secondary cell group has occurred (operation example 2).

In the operation example 1, the UE 200 executes the random access procedure based on the instruction from the eNB 100A to execute the random access procedure. However, in the present operation example, the random access procedure is executed at an initiative of the UE 200 after the UE 200 has returned to the PSCell. A part of the communication sequence that is different from the operation example 1 is mainly explained below, and a part that is similar to the operation example 1 is appropriately omitted.

The UE 200 judges whether the PSCell quality, specifically, the cell reception quality has satisfied the predetermined value (Step S65).

Similar to the Measurement Reporting shown in the operation example 1, the UE 200 measures the cell reception quality (RSRP, RSRQ, SINR, and the like) in the PSCell and judges whether the cell reception quality exceeds a predetermined value.

The UE 200 can be notified of the predetermined value by the eNB 100A. For example, the UE 200 can be notified of the predetermined value by using the RRC Connection Reconfiguration that configures the SCG split bearer.

The UE 200 executes, when the cell reception quality of the PSCell satisfies the predetermined value, the random access procedure with the PSCell (gNB 100B) (Step S90).

### (4) Effects and Advantages

The following operational effects can be obtained according to the embodiments explained above. Specifically, the eNB 100A can reconfigure, when reconnecting the UE 200 to the same SCG as that before the release of the resources from the layer below the predetermined layer (RLC layer) of the split bearer B_{SP}, the split bearer B_{SP} by using the retained upper layer resources (PDCP layer and above). Moreover, the eNB 100A instructs the UE 200, when reconfiguring the split bearer B_{SP}, to execute the random access procedure with the gNB 100B included in the SCG to which the UE 200 is reconnected.

Therefore, the process delay can be greatly reduced by using the RRC layer message compared to when the split bearer B_{SP} is reconfigured by using the retained upper layer resources. In other words, because the resources of the upper layers of split bearer B_{SP} are retained, it is possible to quickly reconfigure the split bearer B_{SP} by executing only the random access procedure, instead of reconfiguring the connection in the RRC layer.

Moreover, because the process delay can be reduced, short interruptions (for example, about 20 milliseconds (ms)) in the data communication can also be suppressed.

That is, according to the eNB 100A, because a part of the resources is retained in the case when a split bearer via the SCG is configured, it is possible to suppress the signaling caused due to the repeated release and configuration of the split bearer B_{SP} and to reduce the delay caused due to reconfiguration of the split bearer B_{SP}.

Moreover, as shown in the operation example 2 (see FIG. 6), the split bearer B_{SP} can be similarly configured at the initiative of the UE 200 itself, instead of being configured based on the instruction from the eNB 100A. According to such reconfiguration of the split bearer B_{SP} at the initiative of the UE 200, the processing load on the network side (eNB 100A) can be reduced and the delay associated with the reconfiguration of the split bearer B_{SP} can be reduced.

In the present embodiment, PDCCH or MAC CE can be used in the instruction issued by the eNB 100A to execute random access procedure. Therefore, depending on the implementation or requirements of the UE 200 and the eNB 100A, the UE 200 can be instructed to execute the random access procedure.

In the present embodiment, it is possible to prioritize the execution of the random access procedure with the cell that belongs to a TAG that includes the PSCell. Therefore, it is possible to quickly resume the UL transmission via a cell (SCell) that belongs to the TAG that includes the PSCell.

In the present embodiment, the UE 200 can transmit to the eNB 100A, the SCG recovery Information that indicates that the UE 200 has returned to the SCG. Therefore, the eNB 100A can quickly and certainly recognize that the UE 200 has returned to the same SCG (PSCell) as that before the occurrence of the S-RLF and that the UL transmission can be resumed.

### (5) Other Embodiments

Although the contents of the present invention have been explained above by using the embodiments, it is obvious for a person skilled in the art that the present invention is not limited to those embodiments and that various modifications and improvements thereof are possible.

For example, in the embodiments explained above, the eNB 100A is a radio base station (eNB) of the LTE system and constitutes a master base station, whereas the gNB 100B is a radio base station (gNB) of the NR system and constitutes a secondary base station. However, such configuration can be reversed. In other words, the radio base station (gNB) of the NR system can constitute the master base station and the radio base station (eNB) of the LTE system can constitute the secondary base station.

Moreover, the block diagrams used for explaining the embodiments (FIGS. 3 and 4) show functional block diagrams. Those functional blocks (structural components) can be realized by a desired combination of hardware and/or software. Means for realizing each functional block is not particularly limited. That is, each functional block may be realized by one device combined physically and/or logically. Alternatively, two or more devices separated physically and/or logically may be directly and/or indirectly connected (for example, wired and/or wireless) to each other, and each functional block may be realized by these plural devices.

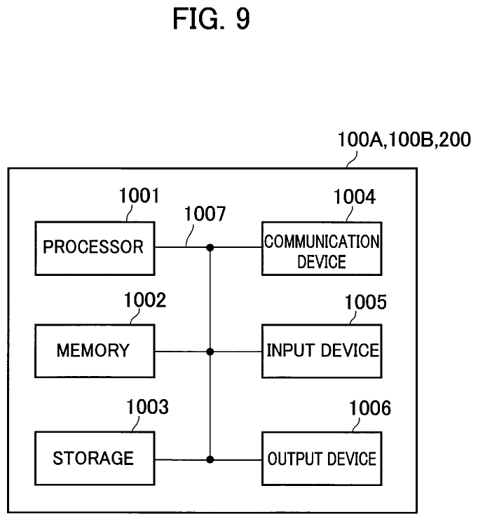

Furthermore, the eNB 100A, the gNB 100B, and the UE 200 (devices) explained above can function as a computer that performs the transmission power control processing of the present invention. FIG. 9 is a diagram showing an example of a hardware configuration of the devices. As shown in FIG. 9, each of the devices can be configured as a computer device including a processor 1001, a memory 1002, a storage 1003, a communication device 1004, an input device 1005, an output device 1006, and a bus 1007.

The functional blocks of the devices (see FIGS. 3 and 4) can be realized by any of hardware elements of the computer device or a desired combination of the hardware elements.

The processor 1001, for example, operates an operating system to control the entire computer. The processor 1001 can be configured with a central processing unit (CPU) including an interface with a peripheral device, a control device, a computing device, a register, and the like.

The memory 1002 is a computer readable recording medium and is configured, for example, with at least one of ROM (Read Only Memory), EPROM (Erasable Programmable ROM), EEPROM (Electrically Erasable Programmable ROM), RAM (Random Access Memory), and the like. The memory 1002 can be called register, cache, main memory (main memory), and the like. The memory 1002 can store therein a computer program (computer program codes), software modules, and the like that can execute the method according to the above embodiments.

The storage 1003 is a computer readable recording medium. Examples of the storage 1003 include an optical disk such as CD-ROM (Compact Disc ROM), a hard disk drive, a flexible disk, a magneto-optical disk (for example, a compact disk, a digital versatile disk, a Blu-ray (Registered Trademark) disk), a smart card, a flash memory (for example, a card, a stick, a key drive), a Floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

In addition, the manner of notification of information is not limited to the one explained in the embodiments, and the notification may be performed in other manner. For example, the notification of information can be performed by physical layer signaling (for example, DCI (Downlink Control Information), UCI (Uplink Control Information)), upper layer signaling (for example, RRC signaling, MAC (Medium Access Control) signaling, notification information (MIB (Master Information Block), SIB (System Information Block)), other signals, or a combination thereof. In addition, the RRC signaling can be called an RRC message, and the RRC signaling can be, for example, an RRC Connection Setup message, an RRC Connection Reconfiguration message, and the like.

Furthermore, the input/output information can be stored in a specific location (for example, a memory) or can be managed in a management table. The information to be input/output can be overwritten, updated, or added. The information can be deleted after outputting. The inputted information can be transmitted to another device.

The order of the sequences, flowcharts, and the like in the embodiments can be rearranged unless there is a contradiction.

Moreover, in the embodiments explained above, the specific operations performed by the eNB 100A (gNB 100B, the same applies to the following) can be performed by another network node (device). Moreover, functions of the eNB 100A can be provided by combining a plurality of other network nodes.

Moreover, the terms used in this specification and/or the terms necessary for understanding the present specification can be replaced with terms having the same or similar meanings. For example, a channel and/or a symbol can be replaced with a signal (signal) if that is stated. Also, the signal can be replaced with a message. Moreover, the terms “system” and “network” can be used interchangeably.

Furthermore, the used parameter and the like can be represented by an absolute value, can be expressed as a relative value from a predetermined value, or can be represented by corresponding other information. For example, the radio resource can be indicated by an index.

The eNB 100A (base station) can accommodate one or more (for example, three) cells (also called sectors). In a configuration in which the base station accommodates a plurality of cells, the entire coverage area of the base station can be divided into a plurality of smaller areas. In each such a smaller area, communication service can be provided by abase station subsystem (for example, a small base station for indoor use RRH: Remote Radio Head).

The term “cell” or “sector” refers to a part or all of the coverage area of a base station and/or a base station subsystem that performs communication service in this coverage. In addition, the terms “base station” “eNB”, “cell”, and “sector” can be used interchangeably in the present specification. The base station can also be referred to as a fixed station, NodeB, eNodeB (eNB), gNodeB (gNB), an access point, a femtocell, a small cell, and the like.

The UE 200 is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

As used herein, the phrase “based on” does not mean “based only on” unless explicitly stated otherwise. In other words, the phrase “based on” means both “based only on” and “based at least on”.

Furthermore, the terms “including”, “comprising”, and variants thereof are intended to be inclusive in a manner similar to “having”. Furthermore, the term “or” used in the specification or claims is intended not to be an exclusive disjunction.

Any reference to an element using a designation such as “first”, “second”, and the like used in the present specification generally does not limit the amount or order of those elements. Such designations can be used in the present specification as a convenient way to distinguish between two or more elements. Thus, the reference to the first and second elements does not imply that only two elements can be adopted, or that the first element must precede the second element in some or the other manner.

Throughout the present specification, for example, during translation, if articles such as a, an, and the in English are added, these articles shall include plurality, unless it is clearly indicated that it is not so according to the context.

As described above, the details of the present invention have been disclosed by using the embodiments of the present invention. However, the description and drawings which constitute part of this disclosure should not be interpreted so as to limit the present invention. From this disclosure, various alternative embodiments, examples, and operation techniques will be apparent to a person skilled in the art.

### INDUSTRIAL APPLICABILITY

According to the radio base station and the user device explained above, the present invention is useful in that, when a split bearer via a secondary cell group (SCG) is configured, it is possible to suppress the signaling caused due to repeated release and configuration of the split bearer and reduce the delay associated with the reconfiguration of the split bearer.

### EXPLANATION OF REFERENCE NUMERALS

10 radio communication system
20 core network
100A eNB
100B gNB
110 radio communication unit
120 connection controlling unit
130 failure notification receiving unit
140 resource controlling unit
150 random access procedure executing unit
200 UE
210 radio communication unit
220 connection controlling unit
230 failure notifying unit
240 cell setting unit
250 quality measuring unit
260 random access procedure executing unit
1001 processor
1002 memory
1003 storage
1004 communication device
1005 input device
1006 output device
1007 bus

1. A radio base station in a radio communication system that is capable of configuring a first bearer that goes from a core network via a secondary cell group and from the secondary cell group splits toward the radio base station included in a master cell group, and in which data is transmitted to a user device via the first bearer, the radio base station comprising:
a failure notification receiving unit that receives from the user device a failure notification that indicates occurrence of a radio link failure in the secondary cell group;
a resource controlling unit that, when the failure notification receiving unit receives the failure notification, releases only resources from a layer lower than a predetermined layer in the secondary cell group of the first bearer and retains resources of a layer upper than the predetermined layer; and
a random access procedure executing unit that executes random access procedure with the user device, wherein
the resource controlling unit reconfigures, when the user device reconnects to the same secondary cell group as that before the release of the resources, the first bearer using the retained upper layer resources, and
the random access procedure executing unit instructs, when the first bearer is reconfigured, the user device to execute the random access procedure with another radio base station that is included in the secondary cell group to which the user device is reconnected.

2. The radio base station as claimed in claim 1, wherein the random access procedure executing unit instructs to execute the random access procedure with a primary secondary cell included in the secondary cell group via a physical downlink control channel.

3. The radio base station as claimed in claim 1, wherein the random access procedure executing unit instructs to execute the random access procedure with a primary secondary cell included in the secondary cell group via a media access control layer.

4. The radio base station as claimed in claim 1, wherein the random access procedure executing unit prioritizes, when a plurality of timing advance groups exists in the secondary cell group, the execution of the random access procedure with a cell that belongs to the timing advance group that includes a primary secondary cell.

5. A user device in a radio communication system that is capable of configuring a first bearer that goes from a core network via a secondary cell group and from the secondary cell group splits toward a radio base station included in a master cell group, and in which data is transmitted to the user device via the first bearer, the user device comprising:
a failure notifying unit that transmits to the radio base station a failure notification that indicates occurrence of a radio link failure in the secondary cell group;
a random access procedure executing unit that executes a random access procedure;
a quality measuring unit that measures a reception quality of a cell in the secondary cell group; and
a connection controlling unit that reconnects the user device to the secondary cell group when the reception quality of the cell measured by the quality measuring unit is equal to or higher than a predetermined threshold value, wherein
only resources from a layer lower than a predetermined layer in the secondary cell group of the first bearer are released and resources of a layer upper than the predetermined layer are retained when the radio link failure occurs,
the connection controlling unit reconfigures the first bearer when the user device reconnects to the same secondary cell group as that before the release of the resources, and
the random access procedure executing unit executes the random access procedure with another radio base station that is included in the secondary cell group to which the user device is reconnected, when the first bearer is reconfigured.

6. The user device as claimed in claim 5, wherein the random access procedure executing unit prioritizes, when a timing advance group exists in the secondary cell group, the execution of the random access procedure with a cell that belongs to the timing advance group that includes a primary secondary cell.

7. The user device as claimed in claim 5, wherein the failure notifying unit reconfigures the first bearer and transmits a return notification that indicates that the user device has returned to the secondary cell group.
